(19) United States
(12) Patent Application Publication
(10) Pub. No.: US 2024/0411061 A1
(43) Pub. Date: Dec. 12, 2024

(54) Light Control Film

(71) Applicant: 3M INNOVATIVE PROPERTIES COMPANY, St. Paul, MN (US)

(72) Inventors: Raymond J. Kenney, Woodbury, MN (US); Yehuda E. Altabet, Sharon, MA (US); John M. DeSutter, Maplewood, MN (US); Kenneth A.P. Meyer, Eagan, MN (US); Nicholas C. Erickson, St. Paul, MN (US); Martin B. Wolk, Woodbury, MN (US); James M. Nelson, Lino Lakes, MN (US); Daniel J. Schmidt, Woodbury, MN (US); Caleb T. Nelson, McKinney, TX (US)

(21) Appl. No.: 18/700,470

(22) PCT Filed: Oct. 17, 2022
(86) PCT No.: PCT/IB2022/059945

§ 371 Date: Apr. 11, 2024

Related U.S. Application Data
(60) Provisional application No. 63/273,567, filed on Oct. 29, 2021.

(51) Int. Cl. G02B 5/00

(52) U.S. Cl. CPC G02B 5/003

(57) ABSTRACT

A light control film includes a two-dimensional array of projections arranged across the light control film. A square of a magnitude of a Fourier transform frequency spectrum of the projections includes a plurality of distinct peaks separated by one or more valleys. The peaks and the one or more valleys have respective averages Pavg and Vavg, Pavg/Vavg≥5, such that when light from a substantially Lambertian light source is incident on the light control film, the light control film transmits the incident light with the transmitted light propagating along a transmission axis and having an intensity profile having a full width at half maximum of less than about 120 degrees in each cross-section of the intensity profile that comprises the transmission axis.

### BACKGROUND

A light control film may be generally understood to be a film configured to control the angular distribution of light transmitted through the film. A light control film can include a plurality of louvers and can control the distribution of light in a direction perpendicular to the louvers. Light control films may be used as privacy filters.

### SUMMARY

In some aspects, the present description provides a light control film including a two-dimensional array of projections arranged across the light control film. A square of a magnitude of a Fourier transform frequency spectrum of the projections includes a plurality of distinct peaks separated by one or more valleys. The peaks and the one or more valleys can have respective averages Pavg and Vavg, Pavg/Vavg≥5, such that when light from a substantially Lambertian light source is incident on the light control film, the light control film transmits the incident light with the transmitted light propagating along a transmission axis and having an intensity profile having a full width at half maximum (FWHM) of less than about 120 degrees in each cross-section of the intensity profile that includes the transmission axis.

In some aspects, the present description provides a light control film including a two-dimensional array of projections arranged across the light control film. A square of a magnitude of a Fourier transform frequency spectrum of the projections can include a plurality of regularly arranged distinct peaks separated by one or more valleys, such that when light from a substantially Lambertian light source is incident on the light control film, the light control film transmits the incident light with the transmitted light propagating along a transmission axis and having an intensity profile having a full width at half maximum of less than about 120 degrees in each cross-section of the intensity profile that includes the transmission axis.

These and other aspects will be apparent from the following detailed description. In no event, however, should this brief summary be construed to limit the claimable subject matter.

### BRIEF DESCRIPTION OF THE DRAWINGS

FIG. 1A is a schematic cross-sectional view of a light control film, according to some embodiments.

FIG. 1B is a schematic cross-sectional view of a light control film and a substantially Lambertian light source, according to some embodiments.

FIG. 2 is a schematic perspective view of a projection, according to some embodiments.

FIG. 3 is a schematic cross-sectional view illustrating adjacent projections, according to some embodiments.

FIG. 4 is a schematic perspective view of a light absorbing annular wall, according to some embodiments.

FIG. 5 is a schematic illustration of various exemplary shapes for an annular wall, according to some embodiments.

FIG. 6 is a schematic perspective cross-sectional view a portion of a light control film, according to some embodiments.

FIG. 7 is a schematic top view of a light control film, according to some embodiments.

FIG. 8A is a schematic top view of a light control film and a cross-section of the light control film in a plane substantially perpendicular to the light control film, according to some embodiments.

FIG. 8B is a schematic representation of cross-sections spanning a total azimuthal angle of α1+α2+α3+α4, according to some embodiments.

FIGS. 9-10 are schematic cross-sectional views of light control films in cross-sections substantially perpendicular to the light control films, according to some embodiments.

FIGS. 11A-11B are schematic top views of portions of arrays of projections of light control films, according to some embodiments.

FIGS. 12A-12B are conoscopic plots of the intensity of light transmitted through the light control films of FIGS. 11A-11B, respectively, according to some embodiments.

FIGS. 13A-13B are plots of a square of a magnitude of a Fourier transform frequency spectrum of the projections of the light control films of FIGS. 11A-11B, respectively, according to some embodiments.

FIG. 14 is a plot of a peak of the square of the magnitude of the Fourier transform frequency spectrum of FIG. 13A, according to some embodiments.

FIG. 15 is plot showing two peaks of the square of the magnitude of the Fourier transform frequency spectrum of FIG. 13A for spatial frequencies along a first direction, according to some embodiments.

FIG. 16 is plot showing multiple peaks of the square of the magnitude of the Fourier transform frequency spectrum of FIG. 13B for spatial frequencies in a two-dimensional spatial frequency space, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Light control films, according to some embodiments of the present description, include structures and coatings that provide light management in substantially all directions (e.g., along directions in each of a plurality of cross-sections that, in combination, cover a total azimuthal angle of at least 350 degrees) simultaneously, unlike traditional privacy films which provide cutoff of light from side to side only along one dimension. In some embodiments, a film is formed by creating arrays of frusta on a substrate from microreplication tools. In some embodiments, the resulting films are coated using Layer-by-Layer (LbL) assembly, for example, to provide a light absorbing coating, followed by selective removal of the coating from the horizontal surfaces of the film with Reactive Ion Etching (RIE), for example. The resulting film, according to some embodiments, when placed in front of a display, for example, provides high transmission directly on-axis, but limits light output beyond a certain angle (e.g., a predetermined half viewing angle) in substantially all directions.

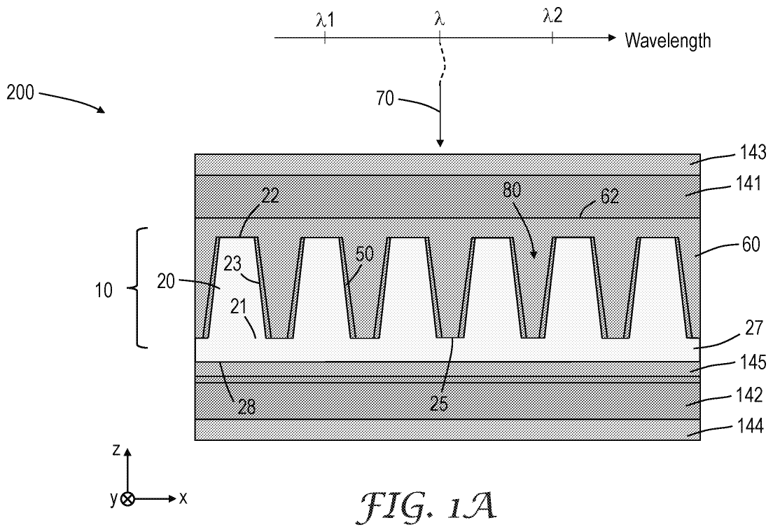

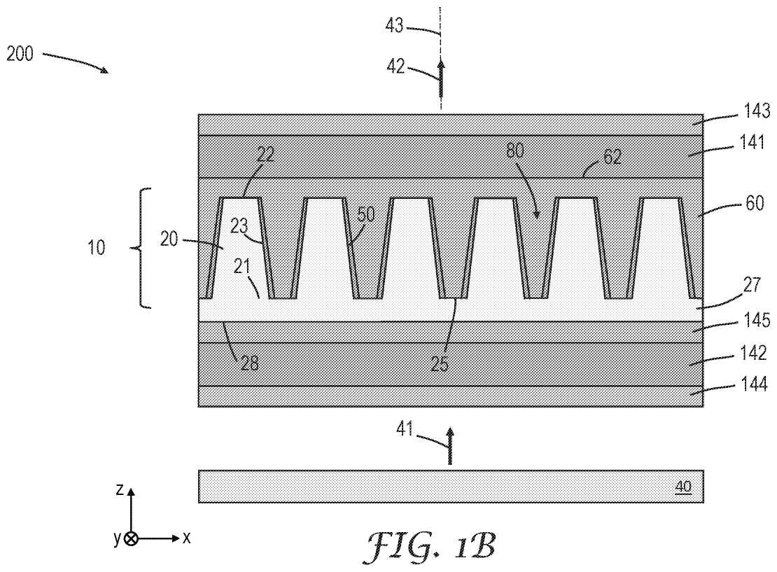

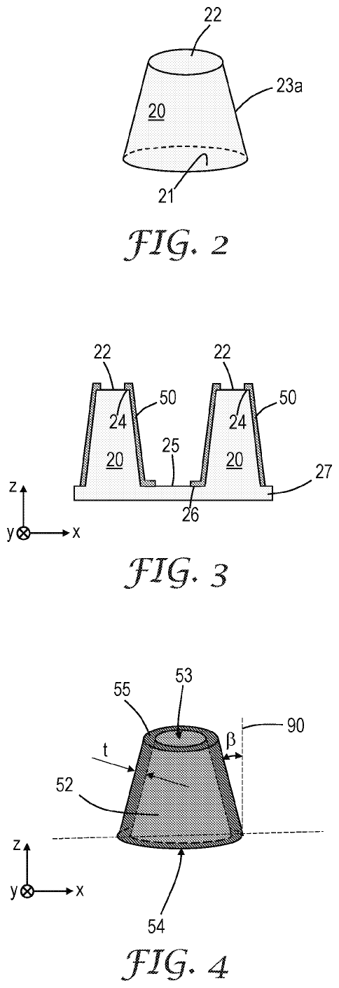

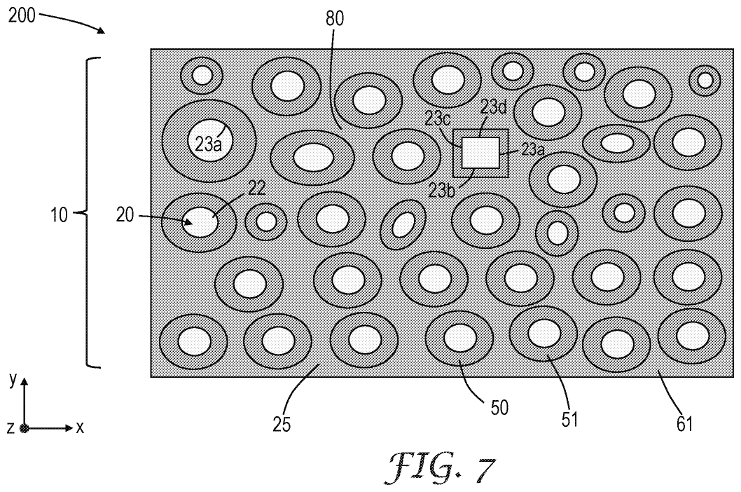

FIGS. 1A-1B are schematic cross-sectional views of a light control film 200, according to some embodiments. FIG. 1A schematically illustrates light 70 substantially normally incident on the light control film 200, while FIG. 1B schematically illustrates light 41 incident on the light control film 200 from a light source 40 which may be a substantially Lambertian light source. In some embodiments, the light control film 200 includes a two-dimensional array 10 of projections 20 arranged across the light control film 200. FIG. 2 is a schematic perspective view of a projection 20, according to some embodiments. In some embodiments, each of the projections is substantially light transmitting and includes a base 21, a top 22, and one or more sides 23 (e.g., corresponding to side 23a schematically illustrated in FIG. 2 or side(s) 23a-23d schematically illustrated in FIG. 7) connecting the top 22 to the base 21. The side(s) of the projections can be coated with a substantially light absorbing material 50. In some embodiments, for each of at least 50%, or 60%, or 70%, or 80%, or 90%, or 95%, or 98%, or 99%, or 99.5% of the projections, at least 80% of a total area of the one or more sides of the projection is coated with a substantially light absorbing material 50. In some embodiments, for each of at least 50% of the projections, at least 85%, or 90%, or 95% of a total area of the one or more sides of the projection is coated with a substantially light absorbing material 50. In some embodiments, for each of at least 60%, or 70%, or 80%, or 90%, or 95%, or 98%, or 99%, or 99.5% of the projections, at least 80%, 85%, or 90%, or 95% of a total area of the one or more sides of the projection is coated with a substantially light absorbing material 50. In some embodiments, for each of at least 50%, or 60%, or 70%, or 80%, or 90%, or 95%, or 98%, or 99%, or 99.5% of the projections, the one or more sides of the projection is coated with a substantially light absorbing material 50 to define a light absorbing angular wall 55 (see, e.g., FIG. 4), as described further elsewhere herein.

An element of a light control film is substantially light transmitting when greater than 50 percent of light (e.g., light 70) in a visible wavelength range (e.g., the range λ1 to λ2 schematically illustrated in FIG. 1A) incident on the element when the light is substantially normally (e.g., within 20, 15, 10, or 5 degrees of normal) incident on the light control film is transmitted through the element. The visible wavelength range may be from about 400 nm to about 700 nm or about 420 nm to about 680 nm. For example, the wavelength λ1 may be about 400 nm or about 420 nm and the wavelength 22 may be about 700 nm or about 680 nm. An element of a light control film is substantially light absorbing when greater than 50 percent of light (e.g., light 70) in a visible wavelength range incident on the element when the light is substantially normally incident on the light control film is absorbed by the element. In some embodiments, for each of the projections, greater than 60, 70, or 80 percent of light in a visible wavelength range that is substantially normally incident on the light control film and incident on the projection is transmitted through the projection. In some embodiments, for each of the projections having sides(s) coated with a substantially light absorbing material 50, greater than 60, 70, or 80 percent of light in a visible wavelength range that is substantially normally incident on the light control film and incident on the light absorbing coating is absorbed by the light absorbing coating.

The projections 20 can be formed on a substrate 142 and a land layer 27 may be formed with the projections. The projections 20 can be formed using a cast and cure process as generally described in U.S. Pat. Nos. 4,374,077; 4,576,850; 5,175,030; 5,271,968; 5,558,740; and 5,995,690, for example. The materials of the projections 20 and the land layer 27 can be an acrylate material while the substrate 142 can be a polyester substrate such as a polyethylene terephthalate (PET) substrate. The coating 50 can be deposited via layer-by-layer (LbL) self-assembly, for example, and may include a polyelectrolyte stack including an organic polymeric polyion (e.g., cation) and counterion (e.g., anion) including a light absorbing material (e.g., pigment). The coating 50 may include a cladding layer to reduce reflection from the coating. Suitable cladding layers are described in International Appl. Nos. WO 2020/026139 (Schmidt et al.) and WO 2021/130637 (Liu et al.), for example. Portions of the coating deposited on the tops 22 of the projections 20 and/or in regions 25 between projections 20 can be removed via reactive ion etching (RIE), for example. LbL and RIE are generally described in U.S. Pat. Appl. Pub. No. 2020/0400865 (Schmidt et al.), for example.

An optional layer 145 may be disposed on the substrate 142 so that the land layer 27 is formed on the optional layer 145. The optional layer 145 may be a primer layer, for example. An additional substrate 141 (e.g., a PET layer) may be disposed on a substantially planarized (e.g., nominally planarized or planarized up to variations small (e.g., less than 20, 15, 10, or 5 percent) compared to an average height of the protrusions 20) major surface 62 of a planarization layer 60 disposed on the projections 20. Protective coatings (e.g., hardcoats) 143 and 144 may be disposed on the respective substrates 141 and 142 with the substrates 141 and 142 disposed between the protective coatings 143 and 144.

In some embodiments, the planarization layer 60 may have a refractive index within 0.05, 0.04, or 0.03 of a refractive index of each of the protrusions 20 and the land layer 27 for at least one wavelength (e.g., the wavelength λ schematically illustrated in FIG. 1A, which may be 532 nm, 550 nm, or 633 nm, for example) in a wavelength range of 420 nm to 680 nm. For example, the planarization layer 60, the protrusions 20 and the land layer 27 may be formed of a same substantially transmissive material. Suitable transmissive materials include polymers such as acrylates or other polymers commonly used in cast and cure processes, for example. In other embodiments, the planarization layer 60 has a refractive index different from that of the protrusions 20 for the at least one wavelength in a wavelength range of 420 nm to 680 nm. For example, the planarization layer 60 can have a refractive index less than that of the protrusions 20 by at least 0.06, 0.08, or 0.1 for the at least one wavelength.

FIG. 3 is a schematic cross-sectional view illustrating adjacent projections 20, according to some embodiments. In some embodiments, no more than about 20%, or 15%, or 10%, or 5% of a total area of the tops 22 of the projections is covered by any substantially light absorbing material. For example, only a small portion 24 of the top 22 near edge(s) of the top 22 may be covered by the substantially light absorbing material 50 as schematically illustrated in FIG. 3. In some embodiments, the projections 20 define a plurality of substantially flat regions 25 therebetween, and no more than about 20%, or 15%, or 10%, or 5% of a total area of the substantially flat regions 25 is covered by any substantially light absorbing material. For example, only a small portion 26 of the flat region 25 adjacent the projections 20 may be covered by the substantially light absorbing material 50 as schematically illustrated in FIG. 3. In some embodiments, the light control film further includes a continuous land layer 27 disposed on the base-side of the projections and connecting the projections. In some embodiments, the projections 20 and the land layer 27 have a same substantially light transmitting composition. In some embodiments, no more than about 20%, or 15%, or 10%, or 5% of regions 25 of the land area between the projections is covered by any substantially light absorbing material.

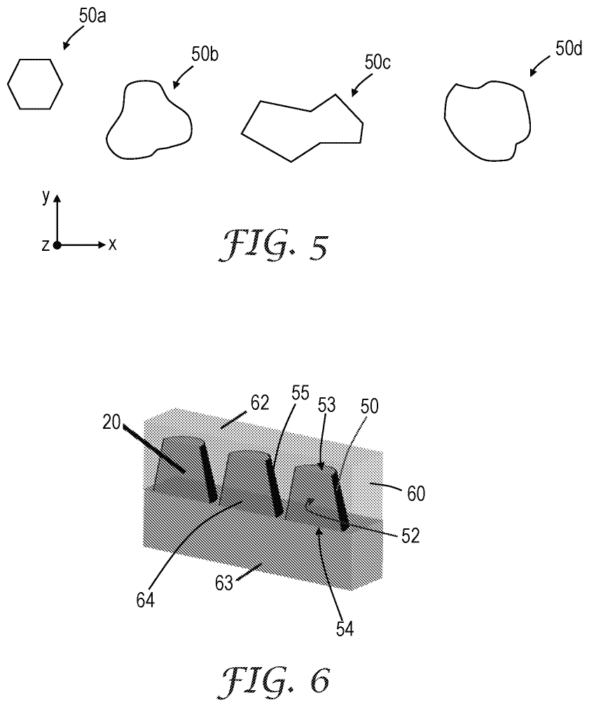

The light absorbing coating of the projections can form a plurality of spaced apart substantially light absorbing annular walls arranged across the light control film. FIG. 4 is a schematic perspective view of a light absorbing annular wall 55, according to some embodiments. In some embodiments, each of the annular walls 55 makes an angle β of less than about 10, or 8, or 6, or 5, or 4, or 3, or 2, or 1.5, or 1 degrees with a normal 90 (along z-direction) to the light control film 200. FIG. 5 schematically illustrates various exemplary shapes for the annular walls in a cross-section (xy-plane) orthogonal to a thickness direction (z-direction) of the light control film 200, according to some embodiments. The annular walls can have circular shapes (see, e.g., FIG. 4), polygonal shapes (e.g., 50a or 50c), hexagonal shapes (e.g., 50a), curvilinear shapes (e.g., 50b), piecewise linear shapes (e.g., 50a or 50c), or piecewise curved shapes (e.g., 50d), for example.

In some embodiments, each of the annular walls span a total azimuthal angle (angle in xy-plane) of at least 350, or 355, or 357, or 358, or 359, or 359.5 degrees. For example, to the extent that an annular wall may not span a full 360 degree azimuthal angle, the annular wall may omit less than a 10 degree span. In some embodiments, each of the annular walls is closed and spans a total azimuthal angle of 360 degrees. In some embodiments, each of the annular walls defines a hollow interior 52 that extends between opposing first 53 and second 54 open ends of the annular wall. In some embodiments, the wall of each of the annular walls has an average thickness t of less than about 2, or 1.75, or 1.5, or 1.25, or 1, or 0.9, or 0.8, or 0.7, or 0.6, or 0.5 microns. The average thickness t can be greater than about 25, 50, or 100 nm, for example.

In some embodiments, an average wall thickness t of less than about 2 microns, or in another range described elsewhere herein, and an angle β of less than about 10 degrees, or in another ranged described elsewhere herein, can contribute to a high on-axis transmission (e.g., greater than about 75, 80, or 85 percent).

FIG. 6 is a schematic perspective cross-sectional view a portion of a light control film, according to some embodiments. In some embodiments, one or more substantially light transmitting materials 60, 63, 64 fully encapsulates, and fully fills the hollow interior 52 of, each of the annular walls 55. For example, the protrusions 20 can be formed from a light transmissive material 64 on a land layer 27 formed from a light transmissive material 63 which may have a same composition as the light transmissive material 64. The protrusions can then be coated with light absorbing material 50 which can be removed from the tops 22. The protrusions can then be backfilled with transparent material 60 which may form a planarization layer. In some embodiments, the light control film 200 includes a planarization layer 60 disposed on the projections 20 and forming a substantially planarized major surface 62.

FIG. 7 is a schematic top view of the light control film 200, according to some embodiments. A two-dimensional array 10 of projections 20 having tops 22 is illustrated. The two-dimensional array 10 can be regular (e.g., repeating) or irregular (e.g., random or pseudo-random). In some embodiments, when the light control film 200 is viewed from the tops-side of the projections, the top of each of the projections is surrounded by a different corresponding closed annulus 51, and each of the closed annuli is completely surrounded by a same common region 61. In some embodiments, a light control film 200 includes a plurality of spaced apart substantially light absorbing annular walls 50, 55 arranged across the light control film, such that a total projected area of the annular walls onto a major surface (see, e.g., major surface 28 schematically illustrated in FIGS. 1A-1B) of the light control film 200 is less than about 40%, or 35%, or 30%, or 25%, or 20%, or 15%, or 10%, or 7.5%, or 5% of a total area of the major surface (e.g., the total area of the major surface along the xy-plane). The projected area can be as little as 1 or 0.5 percent of the total area of the major surface, for example.

In some embodiments, for substantially normally incident light 70 and a visible wavelength range from about 420 nm to about 680 nm, the light control film has average optical transmissions of: greater than about 60% in regions of the light control film corresponding to the tops 22 of the projections 20; less than about 20% in regions of the light control film corresponding to the closed annuli 51; and greater than about 60% in regions of the light control film corresponding to the same common region 61. In some such embodiments, or in other embodiments, the average optical transmission in the regions of the light control film corresponding to the tops 22 of the projections 20 is greater than about 70, 80, or 90 percent. In some such embodiments, or in other embodiments, the average optical transmission in the regions of the light control film corresponding to the closed annuli 51 is less than about 15, 10, 5, 1, or 0.5 percent in regions of the light control film corresponding to the closed annuli 51. In some such embodiments, or in other embodiments, the average optical transmission in the regions of the light control film corresponding to the same common region 61 is greater than about 70, 80, or 90 percent.

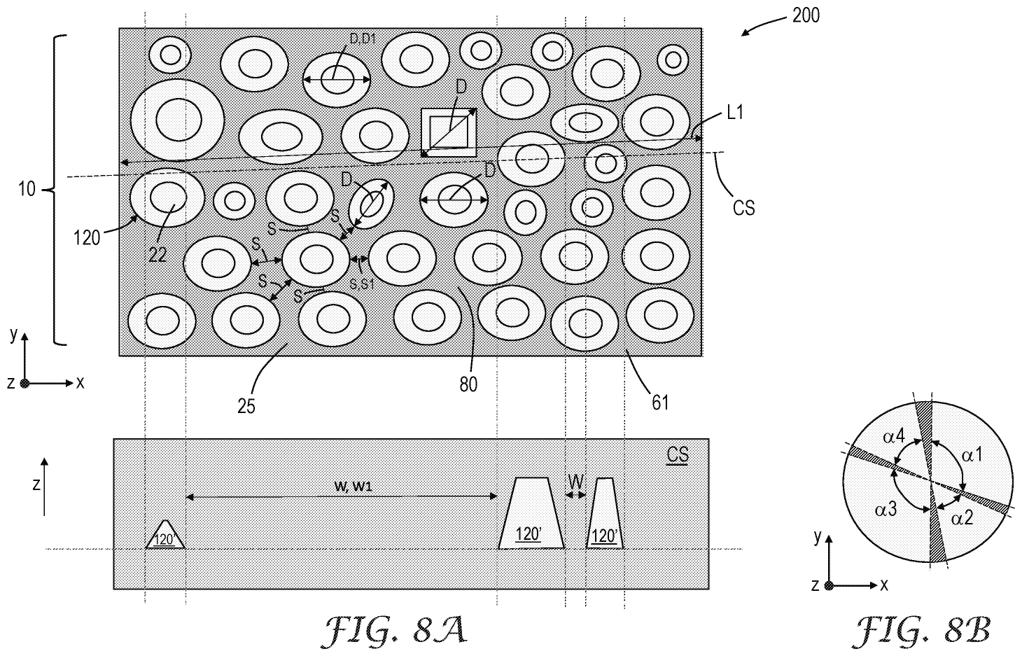

FIG. 8A is a schematic top view of a light control film 200 and a cross-section of the light control film in a plane CS substantially perpendicular (e.g., within 20, 15, 10 or 5 degrees of perpendicular) to the light control film 200, according to some embodiments. In some embodiments, a light control film 200 includes a two-dimensional array 10 of spaced apart posts 120. The posts 120 can be the protrusions 20 with the coatings 50 on the sides of the protrusions. In some embodiments, for a plurality of cross-sections of the light control film in planes (e.g., plane CS) substantially perpendicular to the light control film where the cross-sections, in combination, cover a total azimuthal angle of at least 350, or 355, or 357, or 358, or 359, or 359.5 degrees, or cover a total azimuthal angle of 360 degrees, each of the cross-sections includes a plurality of cross-sectioned posts 120′ of the array of posts. For example, each cross-section parallel to the z-direction (thickness direction of the light control film), with the possible exception of cross-sections spanning a total of less than 10 degrees, can include at least two cross-sectioned posts 120′. FIG. 8B is a schematic representation of cross-sections spanning a total azimuthal angle of α1+α2+α3+α4 which may be at least 350 degrees, for example, or may in any range described above.

In some embodiments, an average of maximum lateral dimensions D of the posts in the array of posts is D1, an average of minimum separations S between adjacent posts in the array of posts is S1, and a maximum of minimum separations W between adjacent cross-sectioned posts in the plurality of cross-sectioned posts is W1, and W1 can be less than about 20, or 18, or 16, or 14, or 12, or 10, or 8, or 6, or 5, or 4, or 3, or 2 times (D1+S1). W1 may be greater than 1, 1.1, 1.2, 1.3 or 1.4 times (D1+S1), for example. In some embodiments, D1 is in a range of about 1 to about 100 microns, or about 2 to about 50 microns, or about 5 to about 25 microns. In some such embodiments, or in other embodiments, the posts have an average height in a range of about 5 to about 200 microns, or about 10 to about 150 microns, or about 20 to about 100 microns. In some such embodiments, or in other embodiments, the posts have an average aspect ratio (average of height divided by D) in a range of about 1 to about 20, or about 1.5 to about 15, or about 2 to about 10.

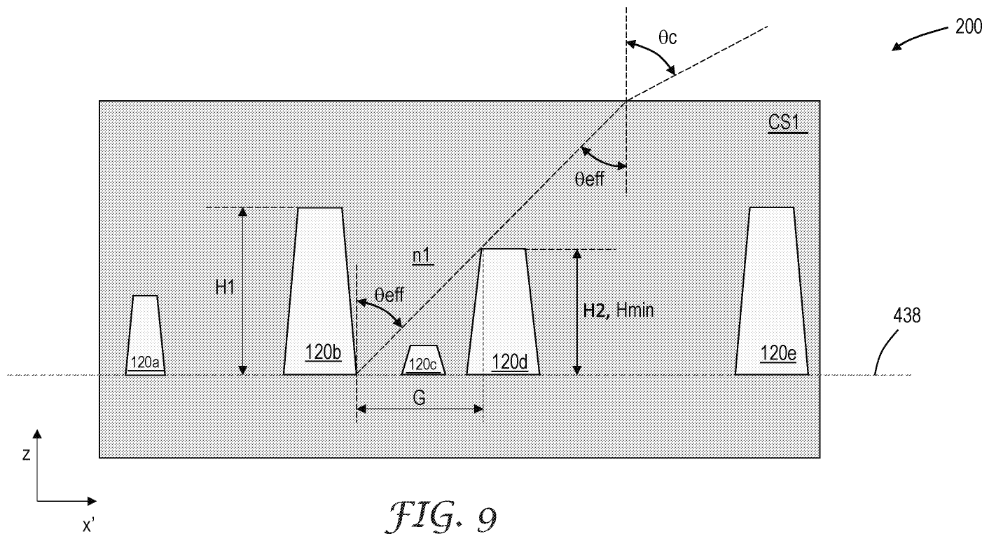

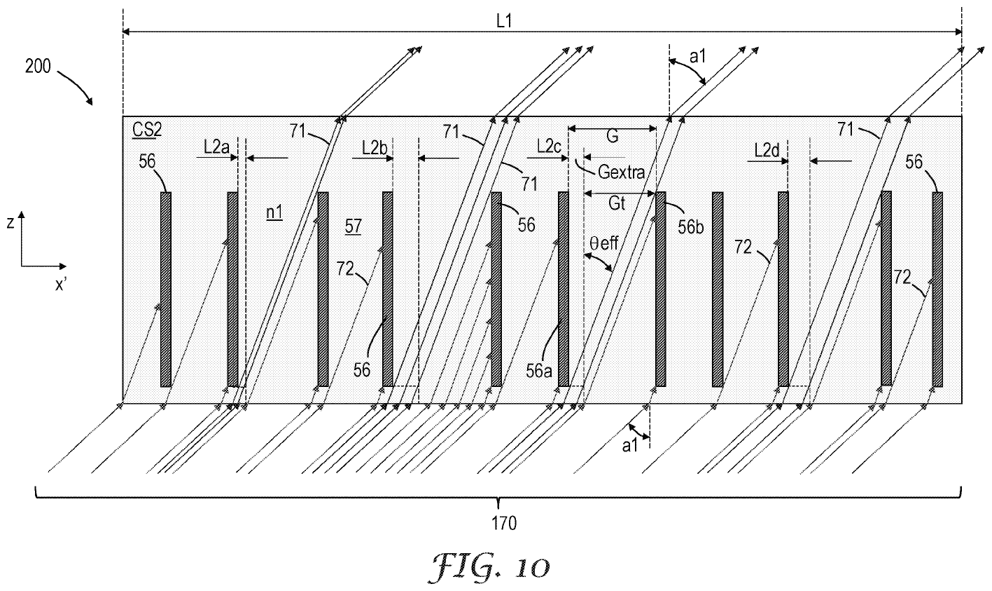

FIG. 9 is a schematic cross-sectional view of a light control film 200, according to some embodiments. In some embodiments, a light control film has a full viewing angle (e.g., 20c) of less than about 120, 110, 100, 90, 80, 70, 60, or 40 degrees in each plane substantially perpendicular to the light control film. The full viewing angle can be greater than about 15, 20, or 25 degrees, for example. In FIG. 9, an angle θeff is defined by the trigonometric relation Tan(θeff)=G/Hmin, where Hmin is the lesser of H1 and H2 which are the maximum heights of posts 120b and 120d in the illustrated cross-section. The first and second cross-sectioned posts may be selected such that the first cross-sectioned post is at least as tall as the second cross-sectioned post (i.e., such that H1 is no less than H2, in which case, Hmin is equal to H2). The angle θc can be related to the angle θeff by Snell's law.

In some embodiments, a light control film 200 includes a two-dimensional array 10 of spaced apart posts 20, 120 defining a plurality of valleys 80 (see, e.g., FIGS. 1, 7, 8A) therebetween. In some embodiments, at least some of the valleys in the plurality of valleys are interconnected. The valleys 80 can be filled with a substantially optically transparent material (e.g., material 60; see, e.g., FIG. 6) having an index of refraction n1 at least one visible wavelength in a visible wavelength range from about 420 nm to about 680 nm. In some embodiments, each cross-section of the light control film in a plane (e.g., plane CS1) substantially perpendicular to the light control film includes a plurality of cross-sectioned posts (e.g., posts 120a-120e) of the array of posts. In some embodiments, for at least first (e.g., 120b) and second (e.g., 120d) cross-sectioned posts in the plurality of cross-sectioned posts, the first and second cross-sectioned posts have respective maximum heights H1 and H2, where: H1 is no less than H2; G is a minimum lateral distance between a bottom of the first cross-sectioned post and a top of the second cross-sectioned post: Tan(θeff) is G/H2: θc is Arc Sin [n1×Sin (θeff)]; and θc≤60, or 55, or 50, or 45, or 40, or 35, or 30, or 25, or 20, or 15 degrees. The angle θc can be greater than about 7.5, 10, or 12.5 degrees, for example. The minimum lateral distance refers to the minimum distance in the plane (e.g., plane CS1) along a direction (x′-direction) substantially orthogonal to a height direction of the first and second cross-sectioned posts between a bottom of first cross-sectioned post and a top of the second cross-sectioned post. In some embodiments, the sidewalls of the cross-sectioned posts are substantially vertical (e.g., making an angle β with a thickness direction of the light control film of less than about 10 degrees or in a range described elsewhere herein) and the distance G is can be taken to be the distance between the first and second cross-sectioned walls (see, e.g., FIG. 10). The height direction of the cross-sectioned posts can be along a thickness direction (z-direction) of the light control film. The bottoms of the first and second cross-sectioned posts, and in some embodiments, bottoms of the plurality of cross-sectioned posts, can be substantially along a same plane 438. The first (e.g., 120b) and second (e.g., 120d) cross-sectioned posts may be adjacent to each other with no other posts therebetween, or one or more other cross-sectioned posts (e.g., 120c) may be disposed between the first and second cross-sectioned posts.

FIG. 10 is a schematic cross-sectional view of a light control film 200, according to some embodiments. The illustrated cross-section CS2 is perpendicular (parallel to z-direction) to the light control film 200. In the illustrated cross-section, the light control film 200 includes a plurality of spaced apart light absorbing cross-sectioned walls 56 of the annular walls 50, 55. The cross-sectioned walls 56 extend along a thickness direction (z-direction) of the light control film. The cross-sectioned walls 56 may extend to some extent in a length direction (x′-direction) while extending primarily along the thickness direction. In some embodiments, the cross-sectioned walls 56 make an angle β (see, e.g., FIG. 4) of less than about 10, or 8, or 6, or 5, or 4, or 3, or 2, or 1.5, or 1 degrees with the thickness direction (z-direction).

In some embodiments, a light control film 200 includes a two-dimensional array 10 of light absorbing annular walls 50, 55 and has an intended half viewing angle a1 of less than about 60, 55, 50, 45, 40, 35, 30, 25, or 20 degrees in each of a plurality cross-sections (e.g., CS2) that are substantially perpendicular to the light control film. In some embodiments, the plurality of cross-sections, in combination, cover a total azimuthal angle of at least 350, or 355, or 357, or 358, or 359, or 359.5 degrees or cover a total azimuthal angle of 360 degrees. In some embodiments, in each of the cross-sections, the light control film 200 includes a plurality of spaced apart light absorbing cross-sectioned walls 56 of the annular walls extending along a thickness direction (z-direction) of the light control film and arranged along a length (x′-direction) of the light control film, where regions between the cross-sectioned walls are filled with a substantially optically transparent material 57 having an index of refraction n1 at least one visible wavelength in a visible wavelength range from about 420 nm to about 680 nm. The light control film has a total length L1 along the length thereof. In some embodiments, for each pair of light absorbing cross-sectioned first (e.g., 56a) and second (e.g., 56b) walls in the plurality of cross-sectioned walls, the first and second cross-sectioned walls are a distance G apart (see, e.g., FIG. 10) and have respective maximum heights H1 and H2 (see, e.g., FIG. 9). The following quantities are useful to define: Hmin is a lesser of H1 and H2: Gt is Hmin×Tan (θeff): θeff is Arc Sin [(Sin (a1))/n1]; Gextra is a maximum of zero and (G-Gt): L2 is a sum of the Gextras for all the pairs of light absorbing cross-sectioned walls in the plurality of cross-sectioned walls; and L1sum and L2sum are sums of the respective L1s and L2s for the plurality of cross-sections. Gextra represents a distance along the length direction (x′-direction) along which light propagating at the angle θeff can pass between the first and second cross-sectioned walls. When G<Gt, light 72 propagating at the angle θeff is blocked by the walls and, as such, Gextra is set to zero. In some embodiments, L2sum/L1sum is less than about 0.25,0.225, 0.20, 0.175, 0.15, 0.125, 0.10, 0.08, 0.06, 0.05, 0.04, 0.03, 0.02, or 0.01. L2sum/L1sum may be as small as 0.005 or 0.0025, for example. L2sum/L1sum can be selected to provide a suitable intensity at the intended half viewing angle a1. L1sum and L2sum can be determined for a sufficiently large number (e.g., at least 10, or at least 20, or at least 30) of representative cross-sections such that L2sum/L1sum does not significantly change when determined over a larger number of cross-sections.

In some embodiments, a light control film 200 includes a two-dimensional array 10 of light absorbing annular walls 50, 55 having an intended half viewing angle a1 of less than about 60, 55, 50, 45, 40, 35, 30, 25, or 20 degrees in each of a plurality cross-sections (e.g., CS2) that are substantially perpendicular to the light control film 200. The plurality of cross-sections may, in combination, cover a total azimuthal angle of at least 350, 355, 357, 358, 359, or 359.5 degrees, or may cover 360 degrees. In some embodiments, in each of the cross-sections, the light control film 200 includes a plurality of spaced apart light absorbing cross-sectioned walls 56 of the annular walls 50, 55 extending along a thickness direction (z-direction) of the light control film and arranged along a length (x′-direction) of the light control film, where the light control film has a total length L1 along the length thereof. In some embodiments, when a substantially planar (e.g., incident within 20, 15, 10, or 5 degrees of the x′z-plane) substantially collimated (e.g., divergence/convergence angle less than 20, 15, 10, or 5 degrees) light beam 170 that propagates in the cross-section and makes the intended half viewing angle a1 with the light control film is incident on the light control film, then the light beam fills a total first length portion L2 (e.g., L2a+L2b+L2c+L2d) of the total length of the light control film along which light rays 71 in the light beam are transmitted by the light control film without encountering any of the light absorbing cross-sectioned walls. In some embodiments, for L1sum and L2sum being sums of the respective L1s and L2s for the plurality of cross-sections, L2sum/L1sum is less than about 0.25, 0.225, 0.20, 0.175, 0.15, 0.125, 0.10, 0.08, 0.06, 0.05, 0.04, 0.03, 0.02, or 0.01.

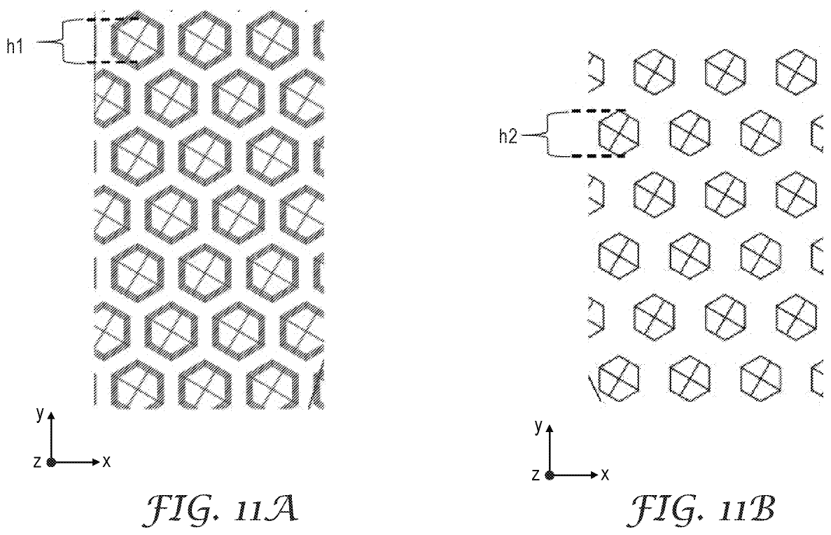

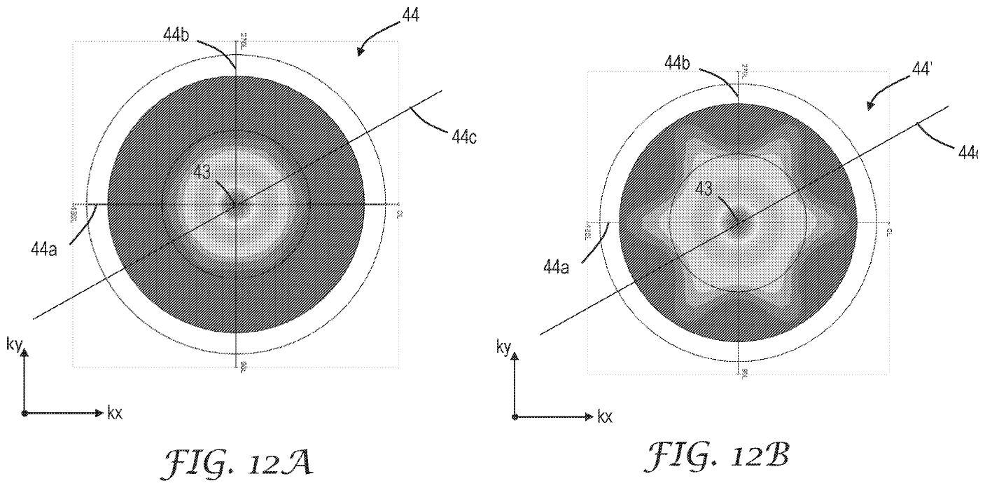

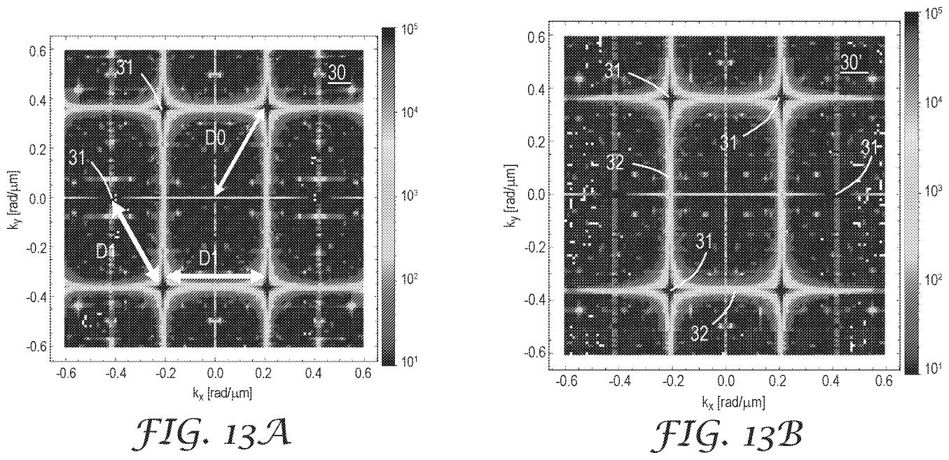

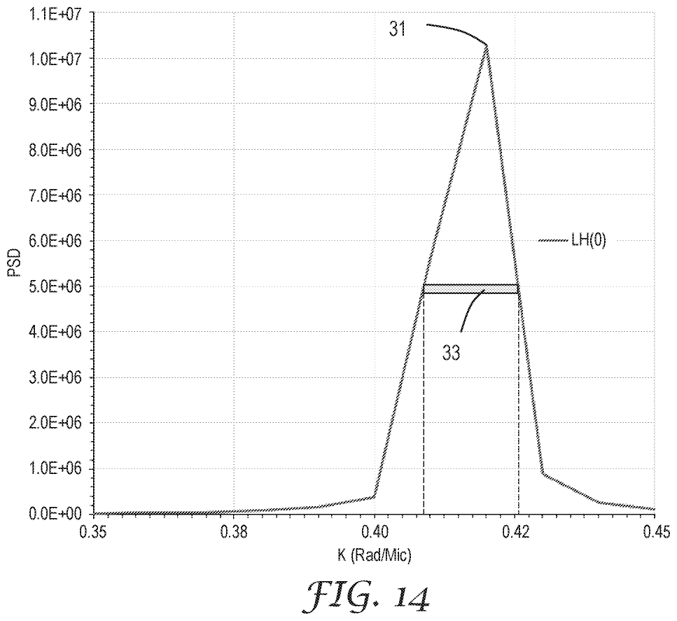

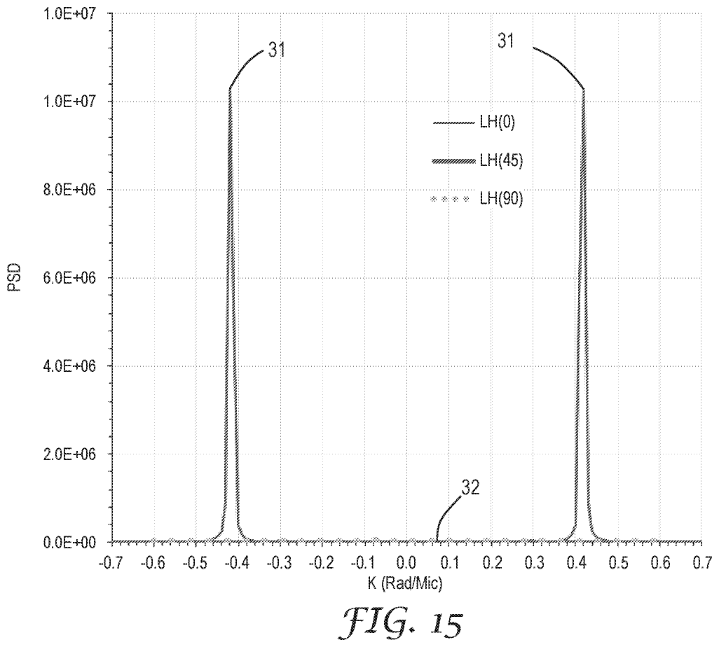

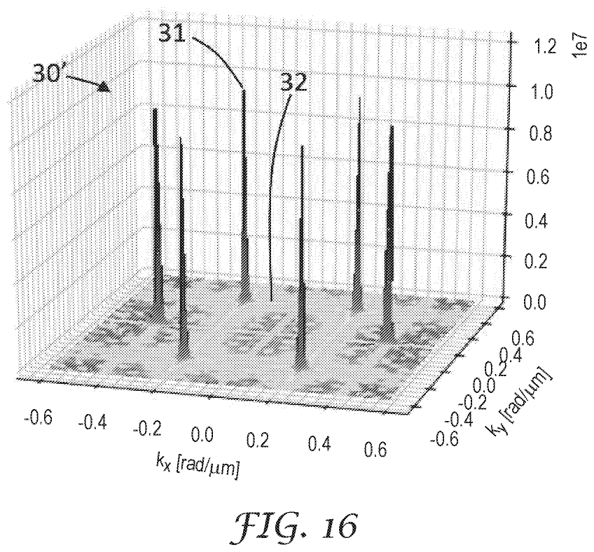

FIGS. 11A-11B are schematic top views of portions of arrays of projections 20 of light control films, according to some embodiments. In the illustrated embodiments, the projections 20 have a substantially hexagonal shape and are arranged on a hexagonal lattice. The hexagons have a size (largest diameter) h1 and h2 in the respective FIGS. 11A-11B where h1>h2. FIGS. 12A-12B are conoscope plots for intensity of light transmitted through the light control films of FIGS. 11A-11B, respectively, according to some embodiments. FIGS. 13A-13B are plots of a square of a magnitude of a Fourier transform frequency spectrum 30, 30′ of the projections 20 of FIGS. 11A-11B, respectively, according to some embodiments. In some embodiments, the Fourier transform is obtained by measuring the heights of the projections as a function of x- and y-coordinates (when the projections extend from a same plane such as z=0) and then taking the Fourier transform of the height. The Fourier transform may be expressed as a function of kx and ky which are spatial frequencies of the respective x and y directions. The square of the magnitude of the Fourier transform frequency spectrum may be referred to as a power spectral density (PSD). FIG. 14 is a plot of a peak 31 of the PSD of FIG. 13A having full width at half maximum (FWHM) 33, according to some embodiments. FIG. 15 is plot showing two peaks 31 of the PSD of FIG. 13A for spatial frequencies along a first direction (e.g., kx direction) and no or substantially no peaks in valleys 32 for spatial frequencies along two other directions (e.g., ky direction and direction at 45 degrees to the kx and ky direction), according to some embodiments. FIG. 16 is plot showing multiple peaks 31 of the PSD of FIG. 13B for spatial frequencies a in a two-dimensional spatial frequency space (kx, ky), according to some embodiments. The plots of FIG. 12A through FIG. 16 were calculated used standard optical modeling techniques, where h1 was 12.3 microns, h2 was 11.2 microns, and the projections had a height of 45 microns.

In some embodiments, a light control film 200 includes a two-dimensional array 10 of projections 20 arranged across (e.g., across x- and y-axes) the light control film 200. In some embodiments, a square of a magnitude of a Fourier transform frequency spectrum 30, 30′ of the projections includes a plurality of distinct peaks 31 separated by one or more valleys 32. The peaks and the one or more valleys can have respective averages Pavg and Vavg, where Pavg/Vavg≥5, 10, 50, 100, 500, or 1000, such that when light 41 from a substantially Lambertian light source 40 (see, FIG. 1B) is incident on the light control film 200, the light control film transmits the incident light with the transmitted light 42 propagating along a transmission axis 43 and having an intensity profile 44, 44′ (see. e.g., FIGS. 12A-12B) having a full width at half maximum (FWHM) of less than about 120 degrees in each cross-section (e.g., cross-sections 44a, 44b, 44c) of the intensity profile that includes the transmission axis. In some embodiments, the FWHM is less than about 110, 100, 90, 80, 70, 60, 40 degrees. The FWHM may be greater than about 25, 20, or 15 degrees, for example. In some embodiments, Pavg/Vavg can be up to about 10⁷, 10⁶, or 10⁵, for example. A substantially Lambertian light source produces a generally Lambertian emission that may have minor deviations from an ideal Lambertian light source.

In some embodiments, the intensity profile 44, 44′ has different FWHMs in different cross-sections (e.g., 44a and 44c) of the intensity profile that include the transmission axis. In some embodiments, along at least one angular direction (e.g., a 0 degree azimuthal angle or along a kx direction), the square of the magnitude of the Fourier transform frequency spectrum of the projections includes two distinct peaks of the plurality of distinct peaks 31 separated by at least 0.1, or 0.15, or 0.2, or 0.25, or 0.3, or 0.35, or 0.4, or 0.45, or 0.5, or 0.55, or 0.6, or 0.65, or 0.7, or 0.75, or 0.8 radians/micron (see, e.g., FIG. 15). The separation may be up to about 5, 3, 2, or 1 radians/micron, for example. The spacings and general pattern of the peaks in the PSD are generally determined by the spacings and general pattern of the array of the projections 20.

In some embodiments, the projections 20 are arranged in an (x, y) space and the square of the magnitude of the Fourier transform frequency spectrum of the projections is in a corresponding (kx, ky) space (e.g., the projections 20 may be described by a height as a function of x- and y-coordinate), where kx and ky are corresponding spatial frequencies of the respective x and y directions. The peaks in the plurality of the distinct peaks can be regularly arranged (e.g., substantially equal spacing between adjacent peaks) in the (kx, ky) space. For example, the peaks may be arranged on the vertices of a regular hexagon or other regular polygon and can be spaced apart by a same nearest-neighbor distance D1. The square of the magnitude of the Fourier transform frequency spectrum may include additional peaks at higher spatial frequencies than those of the vertices of the regular hexagon.

In some embodiments, for an origin in the (kx, ky) space where kx and ky are each zero, a smallest distance D0 between the origin and the distinct peaks in the plurality of distinct peaks is greater than about 0.025, or 0.05, or 0.075, or 0.1, or 0.15, or 0.2, or 0.3, or 0.4, or 0.5 radians/micron. D0 may be up to about 4, 3, 2, or 1 radians/micron, for example.

In some embodiments, a light control film 200 includes a two-dimensional array 10 of projections 20 arranged across (e.g., across x- and y-axes) the light control film 200. In some embodiments, a square of a magnitude of a Fourier transform frequency spectrum 30, 30′ of the projections includes a plurality of distinct peaks 31 separated by one or more valleys 32, such that when light 41 from a substantially Lambertian light source 40 is incident on the light control film, the light control film transmits the incident light with the transmitted light 42 propagating along a transmission axis 43 and having an intensity profile 44, 44′ having a full width at half maximum (FWHM) of less than about 120 degrees in each cross-section (e.g., cross-sections 44a-44c) of the intensity profile that comprises the transmission axis. In some embodiments, the FWHM of the intensity profile 44, 44′ is less than about 110, 100, 90, 80, 70, 60, 40 degrees. The FWHM of the intensity profile 44, 44′ may be greater than about 25, 20, or 15 degrees, for example. The distinct peaks 31 can be regularly arranged (e.g., substantially equal spacing between adjacent peaks in a kx, ky space as described elsewhere herein). In some embodiments, at least one of the peaks has a corresponding full width at half maximum (FWHM) 33 (see, e.g., FIG. 14) of greater than about 0.005, 0.01, 0.015, 0.02, 0.03, 0.04, 0.05, 0.06, 0.07, 0.08, 0.09, 0.1, 0.11, 0.12, 0.13, 0.14, 0.15, 0.16, 0.17, 0.2, or 0.3 radians/micron. The FWHM of the at least one of the peaks may be up to about 2, 1, 0.8, or 0.6 radians/micron, for example. The FWHM of the peaks can be controlled by partially disordering the arrangement of protrusions 20 to broaden the peaks, for example. Broadening the FWHM of the peaks may be desired to provide a more uniform optical transmission, for example.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. A light control film comprising a two-dimensional array of projections arranged across the light control film, a square of a magnitude of a Fourier transform frequency spectrum of the projections comprising a plurality of distinct peaks separated by one or more valleys, the peaks and the one or more valleys having respective averages Pavg and Vavg, Pavg/Vavg≥5, such that when light from a substantially Lambertian light source is incident on the light control film, the light control film transmits the incident light with the transmitted light propagating along a transmission axis and having an intensity profile having a full width at half maximum (FWHM) of less than about 120 degrees in each cross-section of the intensity profile that comprises the transmission axis.

2. The light control film of claim 1, wherein the intensity profile has different FWHMs in different cross-sections of the intensity profile that comprise the transmission axis.

3. The light control film of claim 1, wherein along at least one angular direction, the square of the magnitude of the Fourier transform frequency spectrum of the projections comprises two distinct peaks of the plurality of distinct peaks separated by at least 0.1 radians/micron.

4. The light control film of claim 1, wherein the projections are arranged in an (x, y) space and the square of the magnitude of the Fourier transform frequency spectrum of the projections is in a corresponding (kx, ky) space, where kx and ky are corresponding spatial frequencies of the respective x and y directions, and wherein the peaks in the plurality of the distinct peaks are regularly arranged in the (kx, ky) space.

5. The light control film of claim 4, wherein for an origin in the (kx, ky) space where kx and ky are each zero, a smallest distance between the origin and the distinct peaks in the plurality of distinct peaks is greater than about 0.025 radians/micron.

6. The light control film of claim 1, wherein each of the projections is substantially light transmitting and comprises a base, a top, and one or more sides connecting the top to the base.

7. The light control film of claim 6, wherein, for each of at least 50% of the projections, at least 80% of a total area of the one or more sides of the projection is coated with a substantially light absorbing material.

8. The light control film of claim 7, wherein when the light control film is viewed from the tops-side of the projections, the top of each of the projections is surrounded by a different corresponding closed annulus, and wherein each of the closed annuli is completely surrounded by a same common region.

9. The light control film of claim 8, wherein for substantially normally incident light and a visible wavelength range from about 420 nm to about 680 nm, the light control film has average optical transmissions of:
greater than about 60% in regions of the light control film corresponding to the tops of the projections;
less than about 20% in regions of the light control film corresponding to the closed annuli; and
greater than about 60% in regions of the light control film corresponding to the same common region.

10. A light control film comprising a two-dimensional array of projections arranged across the light control film, a square of a magnitude of a Fourier transform frequency spectrum of the projections comprising a plurality of regularly arranged distinct peaks separated by one or more valleys, such that when light from a substantially Lambertian light source is incident on the light control film, the light control film transmits the incident light with the transmitted light propagating along a transmission axis and having an intensity profile having a full width at half maximum of less than about 120 degrees in each cross-section of the intensity profile that comprises the transmission axis.

11. The light control film of claim 10, wherein each of the projections is substantially light transmitting and comprises a base, a top, and one or more sides connecting the top to the base, wherein for each of at least 50% of the projections, the one or more sides of the projection is coated with a substantially light absorbing material to define a light absorbing angular wall, each of the annular walls spanning a total azimuthal angle of at least 350 degrees and defining a hollow interior that extends between opposing first and second open ends of the annular wall, the wall of each of the annular walls having an average thickness of less than about 2 microns, such that a total projected area of the annular walls onto a major surface of the light control film is less than about 40% of a total area of the major surface.

12. The light control film of claim 11, wherein each of the annular walls makes an angle of less than about 10 degrees with a normal to the light control film.

13. The light control film of claim 10, wherein each of the projections is substantially light transmitting and comprises a base, a top, and one or more sides connecting the top to the base, and wherein, for each of at least 50% of the projections, at least 80% of a total area of the one or more sides of the projection is coated with a substantially light absorbing material.

14. The light control film of claim 13, wherein when the light control film is viewed from the tops-side of the projections, the top of each of the projections is surrounded by a different corresponding closed annulus, and wherein each of the closed annuli is completely surrounded by a same common region.

15. The light control film of claim 14, wherein for substantially normally incident light and a visible wavelength range from about 420 nm to about 680 nm, the light control film has average optical transmissions of:
greater than about 60% in regions of the light control film corresponding to the tops of the projections;
less than about 20% in regions of the light control film corresponding to the closed annuli; and
greater than about 60% in regions of the light control film corresponding to the same common region.
